(19) United States
(12) Patent Application Publication
(10) Pub. No.: US 2012/0166366 A1
(43) Pub. Date: Jun. 28, 2012

(54) HIERARCHICAL CLASSIFICATION SYSTEM

(75) Inventors: Dengyong Zhou, Redmond, WA (US); Lin Xiao, Redmond, WA (US); Mingrui Wu, Bellevue, WA (US)

(73) Assignee: MICROSOFT CORPORATION, Redmond, WA (US)

(21) Appl. No.: 12/975,358

(22) Filed: Dec. 22, 2010

(51) Int. Cl. G06N 5/02; G06F 15/18

(52) U.S. Cl. 706/12; 706/59

(57) ABSTRACT

The claimed subject matter provides a method for hierarchical classification. The method includes receiving a hierarchical structure with a first level comprising a parent node and a sibling node. The structure also includes a second level comprising two child nodes. The method further includes receiving training examples. Each training example may be associated with a class of the parent node, the sibling node, or the two child nodes. The method also includes generating a first classifier for the first level. The first classifier includes a first hyperplane distinguishing the parent and sibling nodes. A first vector is normal to the first hyperplane. Additionally, the method includes generating a second classifier for the second level. The second classifier includes a second hyperplane distinguishing the two child nodes. A second vector is normal to the second hyperplane. An orthogonality of the second vector in relation to the first vector is maximized.

### BACKGROUND

Document and web page categorization may be used in numerous applications. Search engines may categorize queries, and then forward the query to a search engine tailored towards a particular type of search, such as a product search. Categorizations may also be used to select advertising to display for a particular web page.

In many classification problems, a set of possible classes may be organized in a hierarchical structure or a more general taxonomy according to semantic relationships among classes. Classification problems are typically solved by using a classification algorithm to train a classifier. The classifier maps various objects, e.g, documents, web pages, to appropriate classes. The semantic relationship embedded in the hierarchical structure maybe useful in improving classification accuracy.

One classification approach decouples the classification problem into a set of independent classification problems, arranged from the top to the bottom of the hierarchy. At each parent node, a classifier is trained to distinguish the parent node's children from each other.

Another approach uses a generic multiclass classifier. The multiclass Support Vector Machine (SVM) may use a hierarchical structure, such as a category tree. The multiclass SVM merely classifies the leaves of the category tree, ignoring the hierarchical structure.

Several approaches use multi-task and transfer learning to employ hierarchy-induced regularizations that influence the classifiers at adjacent nodes to be as close as possible. As such, these approaches may be more successful at distinguishing dissimilar classes than similar classes. In general, classification approaches may be adept at classifications between dissimilar classes. However, performing classifications between similar classes is challenging.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for hierarchical classification. The method includes receiving a hierarchical structure with a first level comprising a parent node and a sibling node. The structure also includes a second level comprising two child nodes. The method further includes receiving training examples. Each training example may be associated with a class of the parent node, the sibling node, or the two child nodes. The method also includes generating a first classifier for the first level. The first classifier includes a first hyperplane distinguishing the parent and sibling nodes. Additionally, the method includes generating a second classifier for the second level. The second classifier includes a second hyperplane distinguishing the two child nodes. An orthogonality of the second classifier in relation to the first vector is maximized. This procedure may be continued till the bottom of the hierarchical category tree. All steps may also be unified into a single global optimization. In addition, the hyperplanes may be constructed in a feature space defined by a chosen kernel.

An exemplary system according to the subject innovation may be used for hierarchical classification. The exemplary system comprises a processing unit and a system memory that comprises code configured to direct the processing unit to receive the hierarchical structure. The code may also be configured to direct the processing unit to receive training examples. Additionally, the code may be configured to direct the processing unit to generate a first and second classifier for the first and second levels.

Another exemplary embodiment of the subject innovation provides one or more computer-readable storage media that include code to direct the operation of a processing unit. The code may direct the processing unit to receive the hierarchical structure. The code may also be configured to direct the processing unit to receive training examples. Additionally, the code may be configured to direct the processing unit to generate a first and second classifier for the first and second levels.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a hierarchical classification system in accordance with the claimed subject matter;

FIG. 2 is a block diagram of a category tree in accordance with the claimed subject matter;

FIG. 3 is a process flow diagram of a method for hierarchical classification in accordance with the claimed subject matter;

FIG. 4 is a block diagram of an exemplary networking environment wherein aspects of the claimed subject matter can be employed; and

FIG. 5 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “machine learning system,” “visualization system,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

1 Introduction

The classifier at each node of the hierarchical structure may be encouraged to be as different as possible from the classifiers at the parent node. Mathematically, regularization may be used to force the classifying hyperplane at each node to be near-orthogonal to the hyperplane at the parent node. Under typical conditions on the regularization parameters, training such a hierarchical SVM may be a convex optimization problem.

A variant of the dual-averaging method may provide an efficient method for solving the optimization problem. In preliminary experiments on a number of real-world text categorization tasks, the proposed hierarchical classification method out-performs current state-of-the-art methods for hierarchical classification.

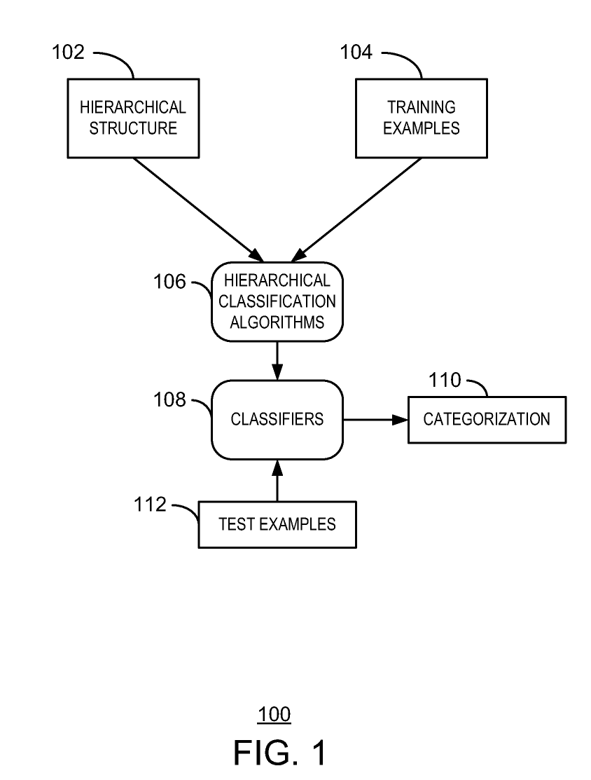

FIG. 1 is a block diagram of a hierarchical classification system 100 in accordance with the claimed subject matter. The hierarchical classification system 100 may include a hierarchical structure 102, training examples 104, hierarchical classification algorithms 106, classifiers 108, a categorization 110, and testing examples 112. The testing examples 112 may be new, unseen examples.

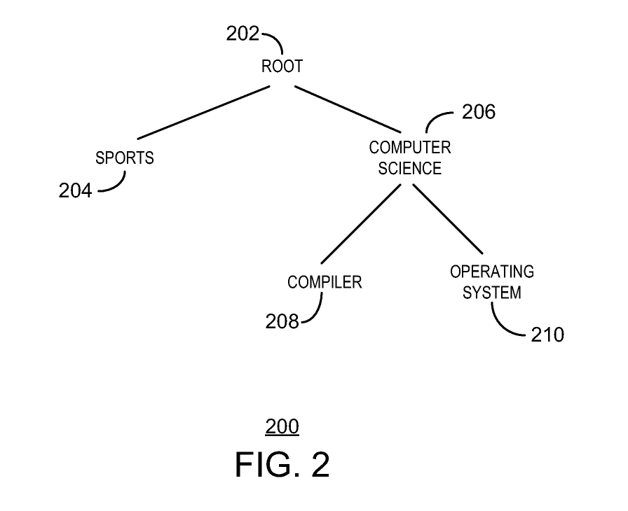

As stated previously, the hierarchical structure 102 includes a taxonomy of possible classes. The hierarchical structure 102 is described in greater detail with respect to FIG. 2.

The training examples 104 may include samples of the objects to be classified, e.g., documents or web pages. The hierarchical structure 102 and the training examples 104 may be input to the hierarchical classification algorithms 106 to generate a classifier 108 for the hierarchical structure 102.

The testing examples 112 may include the real world documents, web pages, etc., that are to be classified into the various classes of the hierarchical structure 102. The categorization 110 may represent the result of classifying the testing examples 112 using the classifiers 108.

FIG. 2 is a block diagram of a category tree 200 in accordance with the claimed subject matter. The category tree 200 may organize classes from top to bottom in semantic relationships that trend from the general to the more specialized. Higher level classes may represent more general abstractions, and lower level classes may be more specific.

As shown, the category tree 200 includes four categories in a hierarchical structure. The terms category and class are used interchangeably herein. As shown, the category tree 200 includes a root node 202, and nodes for the categories of sports 204, computer science 206, compiler 208, and operating system 210.

The top level of categories includes sports 204 and computer science 206. The category of computer science 206 is further divided into categories for operating system 208 and compiler 210.

Multiclass-based classification methods may classify objects, e.g., documents, recursively from the root 202 to the leaves of the category tree 200. At each level of the tree, the document is classified into one of the available categories. Subsequent classifications are then applied to classify the document into one of the child nodes of the selected category. This process repeats until the document is classified to a category represented by a leaf node of the tree.

Accordingly, the classification problem for the category tree 200 may be to map each of a set of documents to a category represented by a leaf node, e.g., sports 204, compiler 208, and operating system 210.

Each—document may be associated with a set of features. The features may be used to distinguish the categories when classifying the documents. Features may include, for example, the frequency of each word in a given document.

The lower level classes of the category tree 200 may share some general features with the higher level classes. However, the lower level classes may also include additional features that are more specific. As such, classifiers 108 at different levels of the hierarchy may use different features, or different combinations of the same features to distinguish among the possible classes.

For example, the word, “computer,” may be a common feature for the documents in the category computer science 206, that is, the categories compiler 208 and operating system 210. However, the documents in the categories compiler 208 and the documents in operating system 210 may have additional features that distinguish them from each other.

A distinguishing feature of the documents in operating system 210 may be the word, “microkernel.” A distinguishing feature of the documents in compiler 208 may be the word, “parsing.” Hence, the word, “computer,” may be a distinguishing feature in the top-level classification between computer science 206 and sports 204, but not in the lower-level classification between operating system 210 and compiler 208.

For example, the words, “microkernel” and “parsing” may be used as positive indications that a document belongs to the category of computer science 206. However, these features may be used differently in the classification between operating system 210 and compiler 208.

In one embodiment, a hierarchical support-vector-machine may be used to train the classifier 108 at a node of the tree to be different from the classifier 108 at the node's ancestor, e.g., parent. In such embodiments, regularizations may be used that influence the normal vector of the classifying hyperplane at a node to be orthogonal, or nearly orthogonal, to the normal vector of the parent node.

Under specific conditions, a convex function of the normal vectors may be determined. Additionally, an efficient dual-averaging method may be used for solving a resulting non-smooth convex optimization problem.

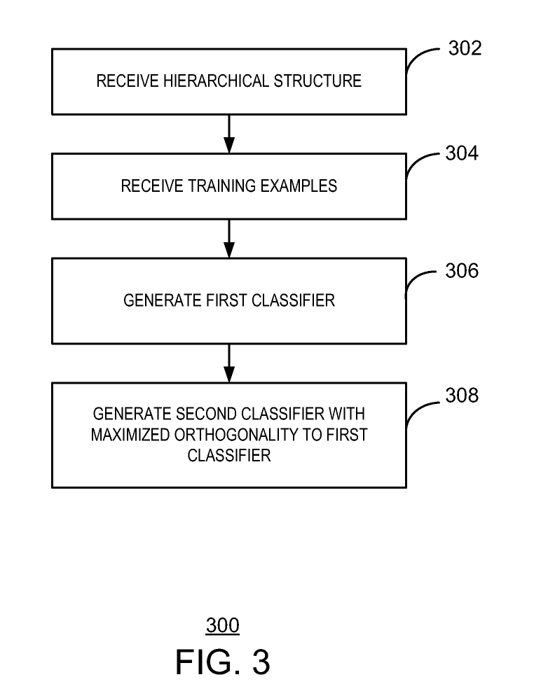

FIG. 3 is a process flow diagram of a method 300 for hierarchical classification in accordance with the claimed subject matter. The method 300 may be performed by the hierarchical classification algorithms 106. It should be understood that the process flow diagram is not intended to indicate a particular order of execution.

The exemplary method 300 begins at block 302, where the hierarchical classification algorithms 106 receive a hierarchical structure 102, such as the category tree 200. The hierarchical structure 102 may include at least a first level and a second level.

The first level may include two nodes: a parent and a sibling of the parent. The second level may also comprise two nodes that are children to the parent node.

At block 304, the hierarchical classification algorithms 106 may receive the training examples 104. Each training example 104 may be associated with one of the classes of the hierarchical structure 102.

At block 306, the hierarchical classification algorithms 106 may generate a classifier 108 for the first level. The classifier 108 for the first level may determine a classification between the parent node and the sibling node.

In one embodiment, the classifier 108 for the first level may include a hyperplane that distinguishes features of the parent and sibling nodes. The hyperplane may be associated with a normal vector.

At block 308, the hierarchical classification algorithms 106 may generate a classifier 108 for the second level. The classifier 108 for the second level may determine a classification between the child nodes of parent node.

In one embodiment, the classifier 108 for the second level may include a hyperplane that distinguishes the child nodes from each other. The hyperplane may be generated so as to maximize the orthogonality of a normal vector in relation to the normal vector of the first level. The generation of the classifiers 108 for the first and second levels is described in greater detail below.

Steps 306 and 308 may be continued till the bottom of the hierarchical structure 102. All steps may also be unified into a single global optimization. In addition, the hyperplanes may be constructed in a feature space defined by a chosen kernel.

2 Problem Setting

Let X⊂Rⁿ be the instance domain and let Y be the set of classes in the category tree 200. The instance domain may represent the training examples 104. The classes in Y may be identified as nodes in the category tree 200. Let L=|Y|. Without loss of generality, assume Y={0, 1, . . . , L−1}, where 0 represents the root of the category tree 200.

For each node vεY, denote by C(v) the set of children of v, S(v) the set of siblings of v, A(v) the set of ancestors of v (excluding itself), and D(v) the set of descendants of v (excluding v). For convenience, also denote A⁺(v)=A(v)∪{v} and D⁺(v)=D(v)∪{v}.

Let {(x₁, y₁), . . . , (xₘ,yₘ)} represent the training examples 104, where each xᵢεX and each yᵢεY. The hierarchical classification algorithms 106 may learn a classification function ƒ: X→Y that attains a small classification error. Each node vεY may be associated with a vector wᵥεRⁿ. Further, classifiers 108, e.g., ƒ(x), may be determined by the following recursive procedure:

$$f ( x ) = \{ \begin{matrix}initializev := 0 \\ while 𝒞 ( v ) is not empty \\ v := {argmax}_{u ∈ 𝒞 ( v )} {w}_{u}^{T} x \\ returnv\end{matrix} \} . \qquad EQUATION 1$$

In other words, a training example 104 may be labeled by sequentially choosing the class for which the associated vector outputs a largest score among its siblings until a leaf node is reached. In this way, the classifier 108 always return a leaf node.

For a testing example (x,y) where the class y is not a leaf node, a classification error is declared if and only if yε(ƒ(x)).

3 Hierarchical SVM with Orthogonal Transfer

In this section, a hierarchical SVM is described for training classifiers of the form shown in EQUATION 1. The task of learning ƒ(x) may be reduced to learning the set of vectors {wᵥ|vε [symbol] }, which correspond to the normal vectors of the classifying hyperplanes.

As stated previously, accurate classifications at different levels of the category tree 200 may rely on different features, or different combinations of the same features. In order to capture such effects, the regularization terms |wᵤ^{T}wᵥ| may be used whenever uε [symbol] (v). These regularizations may maximize the orthogonality of each node's normal vector in relation to the normal vector of the ancestors normal vectors. The orthogonality may be maximized by solving the following optimization problem:

$$\begin{matrix}minimize & \frac{1}{2} {\sum }_{v ∈ 𝓎} k ( v , v ) \vert {w}_{v}^{T} {w}_{v} \vert + {\sum }_{v ∈ 𝓎} {\sum }_{u ∈ 𝒜 ( v )} k ( u , v ) \vert {w}_{u}^{T} {w}_{v} \vert + \frac{c}{m} {\sum }_{i = 1}^{m} {ξ}_{i} \\ subject to & {w}_{v}^{T} {x}_{i} - {w}_{u}^{T} {x}_{i} \geq 1 - {ξ}_{i} , ∀ u ∈ 𝒮 ( v ) , ∀ v ∈ {𝒜}^{+} ( {y}_{i} ) , ∀ i ∈ \{ 1 , … , m \} , \\ & {ξ}_{i} \geq 0 , ∀ i ∈ \{ 1 , … , m \} .\end{matrix} \qquad EQUATION 2$$

The optimization variables of EQUATION 2 are the normal vectors wᵥ for all vεy and the slack variables ξᵢ for all iε{1, . . . , m}. Both the pairwise function k: y×y→R₊ (a nonnegative matrix) and the constant C are parameters that need to be selected before solving the EQUATION 2.

Regarding EQUATION 2, in the constraints, each example (xᵢ, yᵢ) may be used for discriminating its category yᵢ and all its ancestors from their own siblings. Classifier pairs that do not have a common parent do not appear together in a constraint. This reflects the recursive nature of EQUATION 1.

The same slack variable ξᵢ may be used for all discriminative constraints associated with the example (xᵢ, yᵢ). However, the classification margins at different levels in the hierarchy can be effectively differentiated by setting the diagonal coefficients k (v, v).

Further, because w₀ does not appear in the constraints (because the root does not have any sibling), the optimal value for the root node is the all-zero vector. However, the root node is not needed for classification.

3.1 Convexity

A sufficient condition on the nonnegative pairwise function k may be given such that EQUATION 2 is a convex optimization problem.

The following simple choice of the pairwise function k often perform very well in practice:

$$k ( u , v ) = k ( v , u ) = \{ \begin{matrix}\vert {𝒟}^{+} ( v ) \vert & if u = v , \\ α & if u ∈ 𝒜 ( v ) , \\ 0 & else ,\end{matrix} \qquad EQUATION 4$$

where α>0 is a parameter. For many problems in practice, setting α=1 often give a positive definite k, although not always. In any case, the value of α may be reduced, or the diagonal values k (v, v) may be increased, to make k positive definite.

5 Preliminary Experiments

The method 300 has been evaluated on several classification tasks derived from the popular text categorization benchmark called RCV1-v2/LYRL2004. It contains 23,149 training documents and 781,265 test documents, for a total of 804,414 documents. The documents have been tokenized, stopworded and stemmed to 47,236 unique tokens and represented as L2-normalized log TF-IDF vectors. The top categories MCAT, CCAT and ECAT were used to form three classification tasks. GCAT was not considered because the subcategories are flat rather than being organized hierarchically. In each classification task, the top categories are removed that do not have any subcategory to emphasize the effect of hierarchy. In addition, the documents without unique labeling path or leaf node label were discarded. Further, C15 was excluded from CCAT because it is significantly much larger than other categories. E13 and E14 were also excluded from ECAT since their subcategories contain too few training examples. The method 300 was also evaluated on the 20-News dataset which contains 18,846 documents and 61,188 unique tokens. The L2-normalized log TF-IDF vectors were computed instead of using the default term frequency based representation. The two topics comp and rec which contains 8,820 documents and the associated hierarchy were also included in the evaluation.

The method 300 was compared with the following methods:
Flat multiclass SVM. This formulation uses only the leaf classes.
Hierarchical multiclass SVM. This is EQUATION 2 with k(v, v)=1 and k(u, v)=0 if u≠v.
Hierarchical multitask SVM. This is a multitask version of SVM.
Hierarchical SVM (path loss). This is a method with tree-induced losses.
Hierarchical SVM (0/1 loss). This is a method adapted with zero-one losses.

All methods were trained with C=1, which is commonly used in text classification. Different values of C varying from 1 to 100 did not produce any significant difference in classification performance. For the method 300, the parameters in EQUATION 4 are used, where α=1. Algorithm 4 was used to solve all the above formulations.

The average performance over 50 rounds of random splitting of the training/testing datasets was determined For RCV1-v2/LYRL2004, the training/testing split ratio in each round was the same as the default setting. For 20-News, a random sampling of 60% data was used for training, and the remaining for testing. The classification errors based on zero-one loss for all the methods are summarized in Tables 1. The method 300 outperformed others on every task from RCV1-v2/LYRL2004. On 20-News, the method 300 was slightly better than other approaches. A possible explanation is that the hierarchy of RCV1-v2/LYRL2004 is more meaningful than that of 20-News.

TABLE 1
Average classification error (0/1 loss) and standard deviation over 50 random splittings.

| Methods | MACT | CCAT | ECAT | 20-news |
|---|---|---|---|---|
| Flat Multiclass SVM | 5.26 (±0.20) | 21.49 (±0.27) | 11.85 (±0.29) | 11.50 (±0.50) |
| Hier. Multiclass SVM | 4.87 (±0.18) | 21.48 (±0.31) | 12.09 (±0.34) | 11.37 (±0.49) |
| Hier. Multitask SVM | 4.73 (±0.18) | 21.99 (±0.32) | 12.05 (±0.33) | 11.36 (±0.48) |
| Hier. SVM (path loss) | 13.55 (±0.60) | 26.48 (±0.42) | 15.40 (±0.43) | 33.22 (±1.14) |
| Hier. SVM (0/1 loss) | 6.65 (±0.22) | 22.21 (±0.31) | 13.01 (±0.32) | 11.95 (±0.54) |
| Orthogonal Transfer | 3.03 (±0.13) | 17.53 (±0.55) | 10.01 (±0.28) | 11.19 (±0.46) |

6 Conclusions

Advantageously, the method 300 specifically tackles the difficulty of classifying similar classes in the lower levels of the hierarchical structure 102. As understood by one skilled in the art, the method 300 may have applications to learning theory.

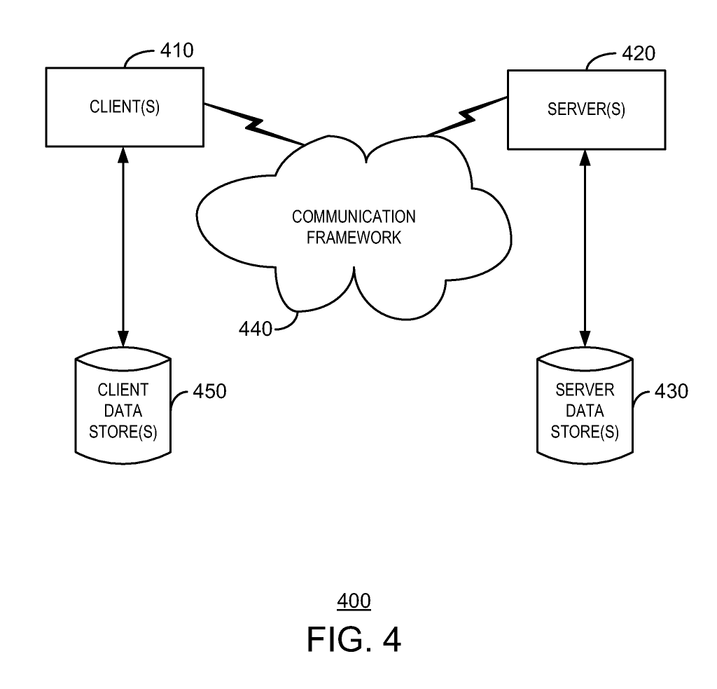

FIG. 4 is a block diagram of an exemplary networking environment 400 wherein aspects of the claimed subject matter can be employed. Moreover, the exemplary networking environment 400 may be used to implement a system and method of visualizing machine learning accuracy.

The networking environment 400 includes one or more client(s) 410. The client(s) 410 can be hardware and/or software (e.g., threads, processes, computing devices). As an example, the client(s) 410 may be computers providing access to servers over a communication framework 440, such as the Internet.

The networking environment 400 also includes one or more server(s) 420. The server(s) 420 can be hardware and/or software (e.g., threads, processes, computing devices). Further, the server(s) may be accessed by the client(s) 410. The servers 420 can house threads to support a hierarchical classification system.

One possible communication between a client 410 and a server 420 can be in the form of a data packet adapted to be transmitted between two or more computer processes. The networking environment 400 includes a communication framework 440 that can be employed to facilitate communications between the client(s) 410 and the server(s) 420.

The client(s) 410 are operably connected to one or more client data store(s) 450 that can be employed to store information local to the client(s) 410. The client data store(s) 450 may be located in the client(s) 410, or remotely, such as in a cloud server. Similarly, the server(s) 420 are operably connected to one or more server data store(s) 430 that can be employed to store information local to the servers 420.

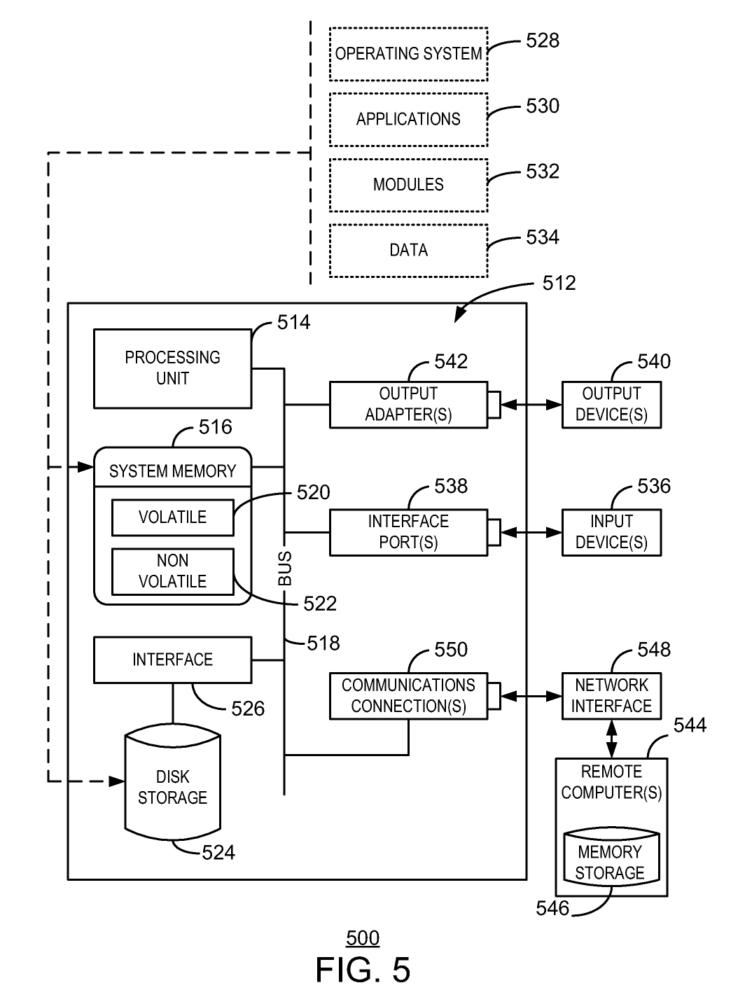

With reference to FIG. 5, an exemplary operating environment 500 for implementing various aspects of the claimed subject matter. The exemplary operating environment 500 includes a computer 512. The computer 512 includes a processing unit 514, a system memory 516, and a system bus 518.

The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structure(s) including the memory bus or memory controller, a peripheral bus or external bus, and/or a local bus using any variety of available bus architectures known to those of ordinary skill in the art. The system memory 516 is non-transitory computer-readable media that includes volatile memory 520 and nonvolatile memory 522.

The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), or flash memory.

Volatile memory 520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 512 also includes other non-transitory computer-readable media, such as removable/non-removable, volatile/non-volatile computer storage media. FIG. 5 shows, for example a disk storage 524. Disk storage 524 includes, but is not limited to, devices like a magnetic disk drive, floppy disk drive, tape drive, Jaz drive, Zip drive, LS-100 drive, flash memory card, or memory stick.

In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in the suitable operating environment 500. Such software includes an operating system 528. Operating system 528, which can be stored on disk storage 524, acts to control and allocate resources of the computer system 512.

System applications 530 take advantage of the management of resources by operating system 528 through program modules 532 and program data 534 stored either in system memory 516 or on disk storage 524. It is to be appreciated that the claimed subject matter can be implemented with various operating systems or combinations of operating systems.

A user enters commands or information into the computer 512 through input device(s) 536. Input devices 536 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 536 connect to the processing unit 514 through the system bus 518 via interface port(s) 538. Interface port(s) 538 include, for example, a serial port, a parallel port, a game port, and a universal serial bus (USB).

Output device(s) 540 use some of the same type of ports as input device(s) 536. Thus, for example, a USB port may be used to provide input to the computer 512, and to output information from computer 512 to an output device 540.

Output adapter 542 is provided to illustrate that there are some output devices 540 like monitors, speakers, and printers, among other output devices 540, which are accessible via adapters. The output adapters 542 include, by way of illustration and not limitation, video and sound cards that provide a means of connection between the output device 540 and the system bus 518. It can be noted that other devices and/or systems of devices provide both input and output capabilities such as remote computer(s) 544.

The computer 512 can be a server hosting a hierarchical classification system in a networked environment using logical connections to one or more remote computers, such as remote computer(s) 544. The remote computer(s) 544 may be client systems configured with web browsers, PC applications, mobile phone applications, and the like, to allow users to request web pages, documents, searches, etc., as discussed herein.

The remote computer(s) 544 can be a personal computer, a server, a router, a network PC, a workstation, a microprocessor based appliance, a mobile phone, a peer device or other common network node and the like, and typically includes many or all of the elements described relative to the computer 512.

For purposes of brevity, only a memory storage device 546 is illustrated with remote computer(s) 544. Remote computer(s) 544 is logically connected to the computer 512 through a network interface 548 and then physically connected via a communication connection 550.

Network interface 548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to the computer 512. The hardware/software for connection to the network interface 548 may include, for exemplary purposes only, internal and external technologies such as, mobile phone switches, modems including regular telephone grade modems, cable modems and DSL modems, ISDN adapters, and Ethernet cards.

An exemplary embodiment of the computer 512 may comprise a server hosting a search engine. The server may be configured to receive a query from a user. The server may also be configured to perform a hierarchical classification of the query, and submit the query to a search engine tailored to the particular class determined by the classification. The search engine results may be generated and provided to the remote computer(s) 544.

An exemplary processing unit 514 for the server may be a computing cluster comprising Intel® Xeon CPUs. The disk storage 524 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for hierarchical classification, comprising:
receiving a hierarchical structure comprising:
a first level comprising:
a parent node; and
a sibling node of the parent node; and
a second level comprising two child nodes of the parent node;
receiving a plurality of training examples, wherein each of the training examples is associated with a class of:
the parent node;
the sibling node; or
one of the two child nodes;
generating a first classifier for the first level, wherein the first classifier comprises a first hyperplane that distinguishes the parent node from the sibling node, wherein a first vector is normal to the first hyperplane; and
generating a second classifier for the second level, wherein the second classifier comprises a second hyperplane that distinguishes the two child nodes, wherein a second vector is normal to the second hyperplane, and wherein an orthogonality of the second vector in relation to the first vector is maximized.

2. The method recited in claim 1, wherein the hierarchical structure comprises a category tree.

3. The method recited in claim 1, wherein generating the second classifier comprises training a hierarchical support vector machine.

4. The method recited in claim 3, wherein training the hierarchical support vector machine comprises solving an optimization problem.

5. The method recited in claim 1, wherein generating the second classifier comprises performing a dual averaging method.

6. The method recited in claim 1, comprising classifying a test example based on the first classifier, the second classifier, and the hierarchical structure to generate a classification.

7. The method recited in claim 6, comprising performing one of the following based on the classification:
displaying an advertisement for a user; or
selecting a search engine.

8. The method recited in claim 1, wherein the plurality of training examples comprises one of:
a search engine query;
a plurality of documents; or
a plurality of web pages.

9. The method recited in claim 1, performed from a top of the hierarchical structure to a bottom of the hierarchical structure.

10. The method recited in claim 1, wherein all steps are unified into a single global optimization.

11. The method recited in claim 1, wherein the first hyperplane is constructed in a feature space defined by a chosen kernel.

12. A system for hierarchical classification, comprising:
a processing unit; and
a system memory, wherein the system memory comprises code configured to direct the processing unit to:
receive a hierarchical structure comprising:
a first level comprising:
a parent node; and
a sibling node of the parent node; and
a second level comprising two child nodes of the parent node;
receive a plurality of training examples, wherein each of the training examples is associated with a class of:
the parent node;
the sibling node; or
one of the two child nodes;
generate a first classifier for the first level, wherein the first classifier comprises a first hyperplane that distinguishes the parent node from the sibling node, wherein a first vector is normal to the first hyperplane; and
generate a second classifier for the second level, wherein the second classifier comprises a second hyperplane that distinguishes the two child nodes, wherein a second vector is normal to the second hyperplane, and wherein an orthogonality of the second vector in relation to the first vector is maximized.

13. The system recited in claim 12, wherein the hierarchical structure comprises a category tree.

14. The system recited in claim 12, wherein generating the second classifier comprises training a hierarchical support vector machine.

15. The system recited in claim 14, wherein training the hierarchical support vector machine comprises solving an optimization problem.

16. The system recited in claim 12, wherein the code configured to direct the processing unit to generate the second classifier comprises code configured to direct the processing unit to perform a dual averaging method.

17. One or more computer-readable storage media, comprising code configured to direct a processing unit to:
receive a category tree comprising:
a first level comprising:
a parent node; and
a sibling node of the parent node; and
a second level comprising two child nodes of the parent node;
receive a plurality of training examples, wherein each of the training examples is associated with a class of:
the parent node;
the sibling node; or
one of the two child nodes;
generate a first classifier for the first level, wherein the first classifier comprises a first hyperplane that distinguishes the parent node from the sibling node, wherein a first vector is normal to the first hyperplane; and
generate a second classifier for the second level, wherein the second classifier comprises a second hyperplane that distinguishes the two child nodes, wherein a second vector is normal to the second hyperplane, and wherein an orthogonality of the second vector in relation to the first vector is maximized.

18. The computer-readable storage media of claim 17, wherein code configured to direct the processing unit to generate the second classifier comprises code configured to direct the processing unit to train a hierarchical support vector machine.

19. The computer-readable storage media of claim 18, wherein the code configured to direct the processing unit to train a hierarchical support vector machine comprises code configured to direct the processing unit to solve an optimization problem.

20. The computer-readable storage media of claim 18, wherein the code configured to direct the processing unit to generate the second classifier comprises code configured to direct the processing unit to perform a dual averaging method.
